(19) United States
(12) Patent Application Publication
(10) Pub. No.: US 2021/0178814 A1
(43) Pub. Date: Jun. 17, 2021

(54) RUBBER COMPOSITION FOR TIRE, AND PNEUMATIC TIRE AND STUDLESS TIRE USING THE SAME

(71) Applicant: Toyo Tire Corporation, Itami-shi (JP)

(72) Inventor: Yugo Sumino, Itami-shi (JP)

(73) Assignee: Toyo Tire Corporation, Itami-shi (JP)

(21) Appl. No.: 17/117,392

(22) Filed: Dec. 10, 2020

(30) Foreign Application Priority Data
Dec. 12, 2019 (JP) 2019-224787

(51) Int. Cl. B60C 1/00; C08F 36/06; C08F 36/08; C08L 1/02; C08K 7/22

(52) U.S. Cl. CPC B60C 1/0016; C08F 36/06; C08K 7/22; C08L 1/02; C08F 36/08

(57) ABSTRACT

A rubber composition for a tire having excellent wet grip performance and on-ice braking performance, and a pneumatic tire and a studless tire using the same are provided. The rubber composition for a tire contains 3 to 30 parts by mass of a diene rubber that is liquid at room temperature, and 0.3 to 20 parts by mass of porous cellulose particles having a porosity of 75 to 95%, with respect to 100 parts by mass of diene rubber that is solid at room temperature.

### BACKGROUND OF THE INVENTION

### 1. Field of the Invention

The present disclosure relates to a rubber composition, and more specifically, to a rubber composition for a tire which can be suitably used for a tread of a pneumatic tire, particularly a studless tire, and a pneumatic tire and a studless tire using the same, for example.

### 2. Description of Related Art

The ice and snow roads are slippery, as they have a considerably lower friction coefficient than that of ordinary roads. Therefore, for a rubber composition used for a tread of a studless tire, in order to improve the ground contact performance on the ice-covered road surface, the rubber hardness at low temperature is kept low by use of butadiene rubber or the like with a low glass transition point, and addition of a softening agent. However, when the rubber hardness is lowered, the tread pattern is likely to be deformed, and there is a problem that the wet grip performance is deteriorated.

Further, in order to increase the frictional force on ice, foam rubber is used for the tread, and hard materials such as hollow particles, glass fibers, and vegetable granules are added.

For example, JP-A-2011-12110 discloses a rubber composition as a rubber composition having excellent on-ice performance, which contains 0.3 to 20 parts by weight of porous cellulose particles having a porosity of 75 to 95% and an average particle diameter of 1000 μm or less with respect to 100 parts by weight of a diene rubber.

### SUMMARY OF THE INVENTION

As described above, although it is known that on-ice braking performance is improved by adding porous cellulose particles, it cannot always be said that it has reached a sufficient level to meet the increasingly stringent market demands these days, and it is required to have both on-ice braking performance and wet grip performance, which are contradictory characteristics.

The present disclosure has been made in view of the problems occurring in the related art described above, and it is an object to provide a rubber composition for a tire having excellent wet grip performance and on-ice braking performance, and a pneumatic tire and a studless tire using the same.

In addition, JP-A-4-110333 describes a rubber composition including a liquid polymer, but it has an object of providing a rubber composition for a tire which has a small change in hardness at a low temperature for a long period of time without deteriorating processability and abrasion resistance, and does not suggest the wet grip performance or on-ice braking performance.

A rubber composition for a tire according to the present disclosure contains 3 to 30 parts by mass of a diene rubber (hereinafter referred to as “liquid diene rubber”) that is liquid at room temperature, and 0.3 to 20 parts by mass of porous cellulose particles having a porosity of 75 to 95%, with respect to 100 parts by mass of diene rubber (hereinafter referred to as “solid diene rubber”) that is solid at room temperature.

The liquid diene rubber described above may contain isoprene rubber and/or butadiene rubber.

The pneumatic tire and the studless tire according to the present disclosure include a tread made of the rubber composition for a tire.

With the rubber composition for a tire of the present disclosure, it is possible to provide a pneumatic tire and a studless tire having excellent wet grip performance and on-ice braking performance.

### DESCRIPTION OF EMBODIMENTS

Hereinafter, matters related to the embodiments of the present disclosure will be described in detail.

Examples of a solid diene rubber in a rubber composition for a tire according to the present embodiment include various diene rubbers usually used for the rubber composition for a tire, such as natural rubber (NR), isoprene rubber (IR), butadiene rubber (BR), styrene-butadiene rubber (SBR), styrene-isoprene copolymer rubber, butadiene-isoprene copolymer rubber, and styrene-isoprene-butadiene copolymer rubber. These diene rubbers can be used in one kind alone or as a blend of two or more kinds thereof. In this example, the “solid diene rubber” refers to a diene rubber that is solid at room temperature of 23° C., and the “solid” means a state having no fluidity.

The solid diene rubber is preferably a blend of natural rubber and other diene rubber, and more preferably, a blend rubber of natural rubber (NR) and butadiene rubber (BR). In this case, when the ratio of BR is too small, it is difficult to obtain the low temperature characteristics of the rubber composition, and conversely, when it is too large, the processability tends to deteriorate and the tear resistance tends to decrease, and accordingly, the ratio of NR/BR is preferably 30/70 to 80/20, more preferably 40/60 to 70/30, in mass ratio.

Examples of the liquid diene rubber include isoprene rubber, butadiene rubber, styrene-butadiene rubber, isoprene-butadiene rubber, isoprene-styrene rubber, isoprene-butadiene-styrene rubber, isobutylene, and ethylene propylene diene rubber (EPDM). These liquid diene rubbers may be modified by carboxylation, methacrylate, or the like. Further, the copolymer may be an alternating copolymer, a block copolymer, or a random copolymer. These liquid diene rubbers may be used in one kind alone or as a blend of two or more kinds thereof. Among these, a liquid diene rubber having a glass transition temperature (Tg) of −50° C. or lower is preferable from the viewpoint of the on-ice braking performance, and specific examples include isoprene rubber and butadiene rubber. In this example, the “liquid diene rubber” refers to a diene rubber that is liquid at room temperature of 23° C. In addition, the glass transition temperature is a value measured at a heating rate of 20° C./min (measurement temperature range: −150° C. to 50° C.) by the differential scanning ccalorimetry (DSC) method in accordance with JIS K7121.

For the liquid diene rubber, commercially available rubber can also be used, and examples of the isoprene rubber include LIR-30, LIR-50, LIR-310, LIR-390, LIR-410, UC-203, UC-102, LIR-290, and LIR-700 manufactured by Kuraray Co., Ltd., examples of the butadiene rubber include LBR-307, LBR-305 and LBR-352 manufactured by Kuraray Co., Ltd., and examples of the styrene-butadiene rubber include L-SBR-820 and L-SBR-841 manufactured by Kuraray Co., Ltd.

The number average molecular weight of the liquid diene rubber is not particularly limited, but is preferably 3000 to 150,000, and more preferably 5000 to 100,000. The number average molecular weight herein is a value measured by gel permeation chromatography (GPC).

The content of the liquid diene rubber (total amount when two or more kinds are used) is 3 to 30 parts by mass, preferably 5 to 20 parts by mass, and more preferably 5 to 15 parts by mass with respect to 100 parts by mass of the solid diene rubber.

The rubber composition for a tire according to the present embodiment includes porous cellulose particles having a porosity of 75 to 95%. The porous cellulose particles are a natural material that is biodegradable, has a porous structure and high chemical stability, and thus is used as deodorants, food waste treatment base materials, tobacco filter base materials, and the like.

The porosity of the porous cellulose particles is not particularly limited as long as it is 75 to 95%, and more preferably 85 to 95%. When the porosity is 75% or more, the effect of improving the on-ice braking performance is easily obtained, and when it is 95% or less, the strength of the particles is maintained and the particles are hardly deformed or crushed when mixed with the rubber component.

The porosity of the porous cellulose particles can be calculated from the following formula by measuring a volume of a sample (that is, the porous cellulose particles) having a constant mass with a measuring cylinder, and obtaining a bulk specific gravity.

Porosity [%]=(volume [ml] of void)/(bulk volume [ml] of sample)×100={(bulk volume [ml] of sample)−(actual volume [ml] of sample)}/(bulk volume [ml] of sample)×100={1−(actual volume [ml] of sample)/(bulk volume [ml] of sample)}×100={1−(bulk specific gravity [g/ml]) of sample/(true specific gravity [g/ml]) of sample}×100

Here, the true specific gravity of cellulose is 1.5.

The content of the porous cellulose particles is 0.3 to 20 parts by mass and preferably 1 to 15 parts by mass with respect to 100 parts by mass of the solid diene rubber. When the content of the porous cellulose particles is within the range described above, the effect of improving the wet grip performance and the on-ice braking performance can be easily obtained.

The average particle diameter of the porous cellulose particles is not particularly limited, but is preferably 1000 μm or less, more preferably 100 to 800 μm, and further preferably 200 to 800 μm. When the average particle diameter is 1000 μm or less as described above, abrasion resistance can be maintained.

The porous cellulose particles are preferably spherical particles having a ratio of long diameter/short diameter of 1 to 2, and more preferably spherical particles having a ratio of long diameter/short diameter of 1 to 1.5. When the particles having such a spherical structure are used, dispersibility of the particles into the rubber composition is improved, and this can contribute to improve on-ice performance and to maintain abrasion resistance

The average particle diameter of the porous cellulose particles and the ratio of long diameter/short diameter thereof are obtained as follows. The porous cellulose particles are observed with a microscope to obtain an image, and using the image, the long diameter and short diameter (in the case where the long diameter and short diameter are the same, a length in a certain axis direction and a length in an axis direction perpendicular to the certain axis direction) are measured in 100 particles and its average value is calculated, and thereby the average particle diameter is obtained. Furthermore, the ratio of long diameter/short diameter is obtained from the average value of values obtained by dividing the long diameter by the short diameter.

The porous cellulose particles are commercially available as “VISCOPEARL” (registered trademark) manufactured by Rengo Co., Ltd., and further are described in JP-A-2001-323095 and JP-A-2004-115284, and those porous cellulose particles can be preferably used.

Specifically, cellulose particles obtained by adding a perforating agent to an alkali type cellulose solution such as viscose and simultaneously proceeding the coagulation/regeneration of cellulose and the foaming by the perforating agent are preferably used as the porous cellulose particles. Examples of the perforating agent include carbonates such as calcium carbonate, and by uniformly mixing and dispersing the carbonate in an alkaline cellulose solution and bringing droplets of the obtained dispersion into contact with an acidic solution such as hydrochloric acid, the acid causes the simultaneous proceeding of the coagulation and regeneration of cellulose and the foaming and decomposition of carbonate, and thereby the porous cellulose particles having a high porosity as described above are obtained.

The rubber composition according to the present embodiment contains the porous cellulose particles having a high porosity and the liquid diene rubber, and when used as a tread rubber for a pneumatic tire such as a studless tire, for example, can greatly improve the wet grip performance and the on-ice braking performance. Although the precise mechanism is not clear, when the porous cellulose particles are added, the pores of the porous cellulose particles effectively absorb and remove water screen present on the ice-covered road surface, and further, the effect of scratching the ice-covered road surface by the crushed particles and the edges of the pore walls is exhibited. It is speculated that by adding the liquid diene rubber, the shear stress of the rubber composition is reduced and the crushing of the porous cellulose particles is suppressed, thereby improving the above-mentioned effect of the porous cellulose particles. Further, it is speculated that by adding the liquid diene rubber, the tan δ of the rubber composition at 0° C. is improved and the wet grip performance is improved.

The rubber composition for a tire according to the present embodiment may contain a petroleum resin. Examples of the petroleum resin include an aliphatic petroleum resin, an aromatic petroleum resin, and an aliphatic/aromatic copolymer petroleum resin. The aliphatic petroleum resin is a resin (also called C5 petroleum resin) obtained by cationically polymerizing an unsaturated monomer such as isoprene or cyclopentadiene that are petroleum fraction (C5 fraction) equivalent to 4 to 5 carbon atoms, and may be hydrogenated. The aromatic petroleum resin is a resin (also called C9 petroleum resin) obtained by cationically polymerizing a monomer such as vinyltoluene, alkyl styrene, and indene that are a petroleum fraction (C9 fraction) equivalent to 8 to 10 carbon atoms, and may be hydrogenated. The aliphatic/aromatic copolymer petroleum resin is a resin (also called C5/C9 petroleum resin) obtained by copolymerizing the C5 fraction and the C9 fraction, and may be hydrogenated.

When the petroleum resin is contained, the content thereof may be 0.1 to 5 parts by mass with respect to 100 parts by mass of the solid diene rubber.

The rubber composition for a tire according to the present embodiment may further include vegetable granules formed by pulverizing seed shells or fruit cores, and/or pulverized porous carbides of the plant, as well as the porous cellulose particles. By using these vegetable granules or pulverized porous carbides in combination, the on-ice braking performance can be further improved.

As the vegetable granules, a pulverized product obtained by pulverizing shells of seeds such as walnut seeds and camellia seeds, or cores of fruit such as peaches and plums by a known method can be used. Since these have a Mohs hardness of about 2 to 5 and are harder than ice, they can exert a scratching effect on the ice-covered road surface.

Vegetable granules surface-treated with a rubber adhesiveness improving agent in order to improve an affinity for a rubber and prevent dropout are preferably used as the vegetable granules. Examples of the rubber adhesiveness improving agent include materials (RFL liquid) including a mixture of a resorcin-formalin resin initial condensate and a latex, as a main component.

The average particle diameter of the vegetable granules is not particularly limited, but is preferably 100 to 600 μm in order to exhibit the scratch effect and prevent dropout from the tread. The average particle diameter is a value measured by a laser diffraction/scattering method, and can be measured using a laser diffraction type particle diameter distribution measuring device “SALD-2200” manufactured by Shimadzu Corporation, which uses a red semiconductor laser (wavelength 680 nm) as a light source, for example.

The pulverized porous carbides is obtained by pulverizing a porous substance including a solid product including, as a main component, carbon obtained by carbonizing a plant such as a tree or bamboo, as a raw material, and among these, a pulverized product of bamboo charcoal (bamboo charcoal powder) exhibits excellent adsorption due to its unique porosity, and so the water screen generated on the ice-covered road surface can be effectively absorbed and removed.

The average particle diameter of the pulverized porous carbides is not particularly limited, but is preferably 10 to 500 μm. The average particle diameter is a value measured by a laser diffraction/scattering method as in the case of the vegetable granules.

When these vegetable granules and pulverized porous carbides are mixed, the total content of both is preferably 0.3 to 20 parts by mass, and more preferably 1 to 10 parts by mass with respect to 100 parts by mass of the diene rubber.

The rubber composition according to the embodiment can appropriately contain compounding chemicals generally used in rubber industries, such as a reinforcing agent and a filler such as carbon black or silica, a process oil, zinc oxide, stearic acid, a softener, a plasticizer, an age resister (amine-ketone type, aromatic secondary amine type, phenol type, imidazole type or the like), a vulcanizing agent and a vulcanization accelerator (guanidine type, thiazole type, sulfenamide type, thiuram type or the like) in ordinary ranges, in addition to each of the above-described components.

In this example, when the carbon black is used for a tread part of a studless tire, the carbon black having a nitrogen adsorption specific surface area (N₂SA) (JIS K6217-2) of 70 to 150 m²/g and a DBP oil absorption amount (JIS K6217-4) of 100 to 150 ml/100 g is preferably used from the viewpoint of the wet grip performance and on-ice braking performance of the rubber composition, and reinforcement of a rubber. Specific examples of the carbon black include carbon blacks of SAF grade, ISAF grade and HAF grade, with its content preferably ranging from about 10 to 80 parts by mass with respect to 100 parts by mass of the diene rubber.

When silica is used, wet silica, dry silica, surface-treated silica, or the like may be used, and the content thereof is preferably 10 to 80 parts by mass with respect to 100 parts by mass of diene rubber from the viewpoint of tan δ balance, reinforcement, and electrical conductivity of the rubber, and the total amount of carbon black and silica is preferably from about 10 to 120 parts by mass. When silica is added, it is preferable to use a silane coupling agent in combination.

The rubber composition according to the present embodiment can be prepared by kneading with a commonly used mixing machine, such as Banbury mixer or a kneader. For example, a rubber composition can be prepared by adding the liquid diene rubber and other additives excluding a vulcanizing agent and a vulcanization accelerator to the solid diene rubber followed by kneading in a first mixing step (non-processing kneading process), and then adding a vulcanizing agent and a vulcanization accelerator to the resultant mixture followed by kneading in a final mixing step (processing kneading process). The rubber composition is suitably used as a rubber composition for a tread part of a pneumatic tire, preferably a studless tire.

The pneumatic tire according to the present embodiment can be produced by preparing a tread part of a tire using the above rubber composition with a rubber extruder or the like, forming an unvulcanized tire, and then performing a vulcanization process according to a conventional method. When the rubber composition of the present disclosure is applied to a studless tire having a cap/base structure, the rubber composition may be applied to only a cap tread at a side of a ground-contact surface.

In the pneumatic tire obtained as described above, by exposing the porous cellulose particles blended in the tread rubber to the surface of the tread, the friction coefficient between the tread rubber and the road surface can be increased and the on-ice braking performance can be improved by the water screen removing effect and scratching effect discussed above. Further, by adding the liquid diene rubber, the tan δ of the rubber composition at 0° C. is improved, so that the wet grip performance can be improved.

### EXAMPLES

Hereinafter, certain examples of the present disclosure are described below, but the present disclosure is not construed as being limited to these examples.

A tread rubber composition for a studless tire was prepared using a Banbury mixer according to the formulations shown in Table 1 below. The details of each component in Table 1 are as follows. The porosity of the walnut shell powder below was based on the above equation for calculating the porosity of the porous cellulose particles, and the true specific gravity was 1.15.
Natural rubber: RSS#3
BR: “BR150B” manufactured by Ube Industries, Ltd.
Liquid IR1: “LIR30” manufactured by Kuraray Co., Ltd. (number average molecular weight=28000)
Liquid IR2: “LIR50” manufactured by Kuraray Co., Ltd. (number average molecular weight=54000)
Liquid BR1: “LBR305” manufactured by Kuraray Co., Ltd. (number average molecular weight=8000)
Liquid BR2: “LBR307” manufactured by Kuraray Co., Ltd. (number average molecular weight=26000)
Porous cellulose particles: “VISCOPEARL MINI” manufactured by Rengo Co., Ltd. (average particle diameter=400 μm, ratio of long diameter/short diameter of particles=1.11, porosity=87%)
Pulverized walnut shell: “SOFT GRIT #46” manufactured by Nippon Walnut Co., Ltd., which has been surface-treated with RFL treatment liquid according to the method described in JP-A-10-7841 (average particle diameter of vegetable granules after treatment=300 μm, porosity=48%)
Carbon black: “SEAST KH (N339, HAF)” manufactured by Tokai Carbon Co., Ltd.
Silica: “NIPSIL AQ” manufactured by Tosoh Silica Corporation
Silane coupling agent: “Si75” manufactured by Evonik Industries, Ltd.
Paraffin oil: “JOMO PROCESS P200” manufactured by JX Nippon Oil & Sun-Energy Corporation
Resin: “Petrotack 90” (C5/C9 petroleum resin) manufactured by Tosoh Co., Ltd.
Age resister: “NOCRAC 6C” manufactured by Ouchi Shinko Chemical Industrial Co., Ltd.
Wax: “OZOACE 0355” manufactured by Nippon Seiro Co., Ltd.
Stearic acid: “LUNAC S-20” manufactured by Kao Corporation
Zinc oxide: “Zinc Oxide #1” manufactured by Mitsui Mining & Smelting Co., Ltd.
Sulfur: “Powdered Sulfur” manufactured by Tsurumi Chemical Industry Co., Ltd.
Vulcanization accelerator 1: “NOCCELER D” manufactured by Ouchi Shinko Chemical Industrial Co., Ltd.
Vulcanization accelerator 2: “SOXINOL CZ” manufactured by Sumitomo Chemical Co., Ltd.

For each of the obtained rubber compositions, the crushing rate of the porous cellulose particles was measured. In addition, studless tires having a tread applied with each rubber composition were produced, and the wet grip performance and on-ice braking performance were evaluated. Each measurement and evaluation method is as follows.
Crushing rate of porous cellulose particles: A test piece vulcanized at 160° C. for 20 minutes was cut at an arbitrary location, and the cross section thereof was measured at a magnification of 30 using a scanning electron microscope (SEM). Fifty holes were arbitrarily selected from the holes appearing in the obtained image, and the long diameter/short diameter of each thereof were measured. The cross-sectional area of each hole was calculated with the opening of the hole as an ellipse, and the average value thereof was calculated. The crushing rate of Comparative Example 3 was set to 100%, and the ratio of the cross-sectional area of the holes of Comparative Example 3 to the cross-sectional area of the holes of each Example (Comparative Example 3/Example×100) was shown in Table 1 as the crushing rate. It shows that the larger the crushing rate, the more the cellulose particles were crushed.
Wet grip performance: Studless tires described above were mounted to a 2000 cc FR vehicle, and the braking distance was measured while operating the ABS at 80 km/h on a road surface sprayed with water of about 1 mm at a temperature of 23° C. to 26° C. (average value of n=10), and the index was indicated with Comparative Example 3 as 100. It shows that the larger the index, the shorter the braking distance and the better the wet grip performance.
On-ice braking performance: Studless tires described above were mounted to 2000 cc 4WD vehicles, and the braking distance on ice was measured while operating the ABS at 40 km/h at a temperature of −2° C. to −6° C. (average value of n=10), and the index was indicated with Comparative Example 3 as 100. It shows that the larger the index, the shorter the braking distance and the better the on-ice braking performance.

TABLE 1

| | Com. 1 | Com. 2 | Com. 3 | Ex. 1 | Ex. 2 | Ex. 3 | Ex. 4 | Ex. 5 | Ex. 6 | Ex. 7 |
|---|---|---|---|---|---|---|---|---|---|---|
| Natural rubber | 50 | 50 | 50 | 50 | 50 | 50 | 50 | 50 | 50 | 50 |
| BR | 50 | 50 | 50 | 50 | 50 | 50 | 50 | 50 | 50 | 50 |
| Liquid IR 1 | — | 10 | — | 10 | — | — | — | 25 | 15 | 10 |
| Liquid IR 2 | — | — | — | — | 10 | — | — | — | — | — |
| Liquid BR 1 | — | — | — | — | — | 10 | — | — | — | — |
| Liquid BR 2 | — | — | — | — | — | — | 10 | — | — | — |
| Porous cellulose particles | — | — | 5 | 5 | 5 | 5 | 5 | 5 | 5 | 4 |
| Pulverized walnut shell | — | — | — | — | — | — | — | — | — | 2 |
| Carbon black | 15 | 15 | 15 | 15 | 15 | 15 | 15 | 15 | 15 | 15 |
| Silica | 50 | 50 | 50 | 50 | 50 | 50 | 50 | 50 | 50 | 50 |
| Silane coupling agent | 4 | 4 | 4 | 4 | 4 | 4 | 4 | 4 | 4 | 4 |
| Paraffin oil | 25 | 15 | 25 | 15 | 15 | 15 | 15 | — | 10 | 15 |
| Resin | 4.5 | 4.5 | 4.5 | 4.5 | 4.5 | 4.5 | 4.5 | 4.5 | 4.5 | 4.5 |
| Age resister | 2 | 2 | 2 | 2 | 2 | 2 | 2 | 2 | 2 | 2 |
| Wax | 1.5 | 1.5 | 1.5 | 1.5 | 1.5 | 1.5 | 1.5 | 1.5 | 1.5 | 1.5 |
| Stearic acid | 2 | 2 | 2 | 2 | 2 | 2 | 2 | 2 | 2 | 2 |
| Zinc oxide | 2 | 2 | 2 | 2 | 2 | 2 | 2 | 2 | 2 | 2 |
| Sulfur | 1.5 | 1.5 | 1.5 | 1.5 | 1.5 | 1.5 | 1.5 | 1.5 | 1.5 | 1.5 |
| Vulcanization | 1 | 1 | 1 | 1 | 1 | 1 | 1 | 1 | 1 | 1 |
| accelerator 1 | | | | | | | | | | |
| Vulcanization | 1.2 | 1.2 | 1.2 | 1.2 | 1.2 | 1.2 | 1.2 | 1.2 | 1.2 | 1.2 |
| accelerator 2 | | | | | | | | | | |
| Crushing rate of porous | — | — | 100 | 73 | 70 | 72 | 68 | 68 | 70 | 74 |
| cellulose particles | | | | | | | | | | |
| Wet grip performance | 100 | 105 | 100 | 105 | 104 | 104 | 103 | 109 | 107 | 104 |
| On-ice braking | 92 | 91 | 100 | 108 | 109 | 108 | 110 | 111 | 110 | 110 |
| performance | | | | | | | | | | |

The results are as shown in Table 1, and from the comparison between Examples 1 to 7 and Comparative Example 3, it can be seen that, by adding the liquid diene rubber to the system in which the porous cellulose particles are blended, the crushing rate of the porous cellulose particles is reduced, and wet grip performance and on-ice braking performance are improved.

From the comparison between Comparative Examples 1 and 2, it can be seen that when the liquid diene rubber is added, but the porous cellulose particles are not added, the wet grip performance is improved, but the on-ice braking performance is lowered.

From the comparison between Comparative Examples 1 and 3, it can be seen that when the porous cellulose particles are added, but the liquid diene rubber is not added, the on-ice braking performance is improved, but the wet grip performance is not improved.

The rubber composition for a tire according to the present disclosure can be used for various tires of, for example, passenger cars, light duty trucks and buses, and is particularly preferably used for studless tires.

What is claimed is:

1. A rubber composition for a tire containing 3 to 30 parts by mass of a diene rubber that is liquid at room temperature, and 0.3 to 20 parts by mass of porous cellulose particles having a porosity of 75 to 95%, with respect to 100 parts by mass of a diene rubber that is solid at room temperature.

2. The rubber composition for a tire according to claim 1, wherein the diene rubber that is liquid at room temperature contains isoprene rubber and/or butadiene rubber.

3. A pneumatic tire comprising a tread formed of the rubber composition for a tire according to claim 1.

4. A pneumatic tire comprising a tread formed of the rubber composition for a tire according to claim 2.

5. A studless tire comprising a tread formed of the rubber composition for a tire according to claim 1.

6. A studless tire comprising a tread formed of the rubber composition for a tire according to claim 2.
